(19) United States
(12) Patent Application Publication
(10) Pub. No.: US 2006/0098828 A1
(43) Pub. Date: May 11, 2006

(54) NETWORK PHONE ADAPTER CAPABLE OF UTILIZING A NORMAL PHONE TO SERVE AS A MICROPHONE AND A SPEAKER

(76) Inventors: Wei-Chung Chu, Taipei Hsien (TW); Ming-Feng Kuo, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,060

(22) Filed: Dec. 14, 2004

Related U.S. Application Data
(60) Provisional application No. 60/522,800, filed on Nov. 9, 2004.

(51) Int. Cl. H04R 3/00

(52) U.S. Cl. 381/110; 398/132; 398/140

(57) ABSTRACT

A phone adaptor capable of utilizing a normal phone to serve as a speaker and a microphone of an electronic device. The phone adaptor includes a speaker driving circuit electrically connected to the electronic device for processing a first audio signal outputted from the electronic device, a microphone driving circuit electrically connected to the electronic device for processing a first phone signal outputted from the normal phone, and a phone signal converting circuit electrically connected to the speaker driving circuit and the microphone driving circuit. The phone signal converting circuit is used either for converting the processed first audio signal into a second phone signal complying with a specification of the normal phone or for converting the processed phone signal into a second audio signal.

### CROSS REFERENCE TO RELATED APPLICATIONS

This application claims the benefit of U.S. provisional Application No. 60/522,800, filed Nov. 9, 2004, which is incorporated herein by reference.

### BACKGROUND OF INVENTION

1. Field of the Invention

The invention relates to a phone adapter, and more particularly, to a network phone adapter capable of utilizing a normal phone to serve as a microphone and a speaker.

2. Description of the Prior Art

Following the popularity of personal computers (PCs) and the Internet, a new communication apparatus, the network phone (for example, the VoIP phone), is provided for users to communicate with each other instead of utilizing a normal phone. The network phone utilizes a specific program run on the PC to provide the above-mentioned communication function through the Internet. Therefore, users do not have to utilize a normal telecom system. Obviously, the network phone saves users money because users pay the Internet service provider a low price compared with that charged by the telecom system provider.

But there are still some problems here. For example, because the network phone is a PC-based architecture, users need other specific input devices and output devices to communicate with the PC first in order to successfully communicate with each other. That is, users may have to spend a great deal of money on buying the aforementioned input/output devices (for example, a speaker or a microphone). This may raise the cost of utilizing the network phone.

### SUMMARY OF INVENTION

It is therefore one of the objectives of the claimed invention to provide a network phone adapter capable of utilizing a normal phone to serve as a microphone and a speaker, to solve the above-mentioned problem.

According to an exemplary embodiment of the claimed invention, a phone adaptor capable of utilizing a normal phone to serve as at least a speaker of an electronic device is disclosed. The phone adaptor comprises: a speaker driving circuit electrically connected to the electronic device for processing an audio signal outputted by the electronic device; and a phone signal converting circuit electrically connected to the speaker driving circuit for converting the processed audio signal into a phone signal complying with a specification of the normal phone and for driving the normal phone using the phone signal.

In addition, a phone adaptor capable of utilizing a normal phone to serve as at least a microphone of an electronic device is disclosed. The phone adaptor comprises: a phone signal converting circuit for converting a phone signal outputted from the normal phone into an audio signal; and a microphone driving circuit electrically connected to the electronic device and the phone signal converting circuit for receiving the audio signal, processing the audio signal, and transferring the processed audio signal to the electronic device.

Furthermore, a phone adaptor capable of utilizing a normal phone to serve as a speaker and a microphone of an electronic device is disclosed. The phone adaptor comprises: a speaker driving circuit electrically connected to the electronic device for processing a first audio signal outputted from the electronic device; a microphone driving circuit electrically connected to the electronic device for processing a first phone signal outputted from the normal phone; and a phone signal converting circuit electrically connected to the speaker driving circuit and the microphone driving circuit, the phone signal converting circuit either for converting the processed first audio signal into a second phone signal complying with a specification of the normal phone or for converting the processed phone signal into a second audio signal.

The present invention network phone adaptor bridges audio signals between a computer and a normal phone so that the present invention can utilize a normal phone to act as a microphone and a speaker needed by the computer. Therefore, users do not have to spend additional money on buying these devices. Furthermore, the present invention network phone adaptor is capable of utilizing the normal phone to serve as either a normal phone or a network phone so that the normal phone becomes a multi-function phone convenient to users.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a network phone adapter according to the present invention.

FIG. 2 is a circuit diagram of a power supplying circuit shown in FIG. 1

FIG. 3 is a circuit diagram of a speaker driving circuit shown in FIG. 1

FIG. 4 is a circuit diagram of a microphone driving circuit shown in FIG. 1.

FIG. 5 is a circuit diagram of a phone signal converting circuit shown in FIG. 1.

FIG. 6 is a circuit diagram of a switching circuit shown in FIG. 1.

### DETAILED DESCRIPTION

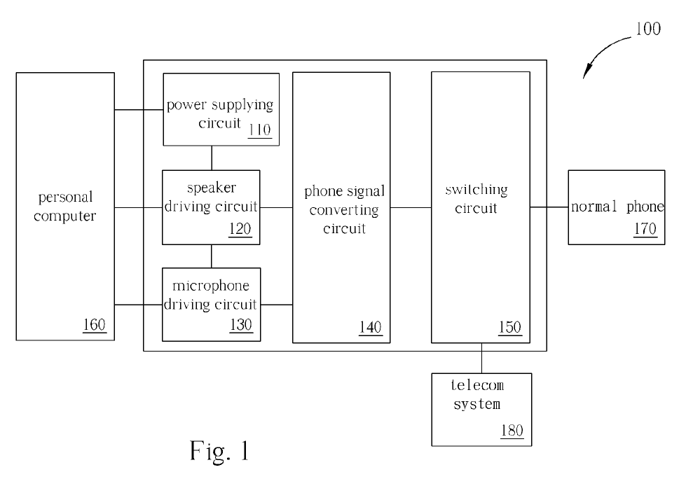

Please refer to FIG. 1, which is a block diagram of a network phone adapter 100 according to the present invention. As shown in FIG. 1, the network phone adapter 100 is electrically connected to a PC 160, a normal phone 170, and a telecom system 180. The network phone adapter 100 comprises a power supplying circuit 110, a speaker driving circuit 120, a microphone driving circuit 130, a phone signal converting circuit 140, and a switching circuit 150. Here, the power supplying circuit 110 is electrically connected to the PC 160 for supplying power to the whole network phone adapter 100.

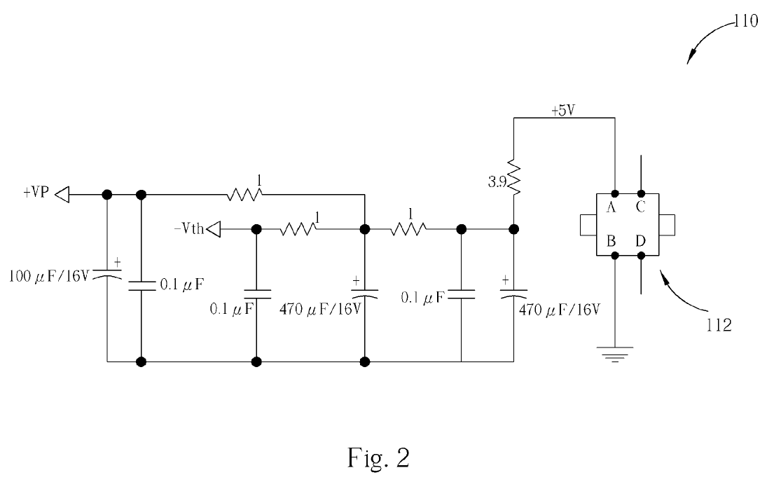

Please refer to FIG. 2, which is a circuit diagram of the power supplying circuit 110 shown in FIG. 1. As shown in FIG. 2, the power supplying circuit 110 is connected to a USB port 112 of the PC 160 so that the power supplying circuit 110 can drain the voltage level, e.g. +5V, from the USB port 112. Please note that connecting nodes A, B, C, D stand for Vcc, GND, +DATA, and −DATA, respectively. As one can see, the connecting nodes C and D are floating in this embodiment because the USB interface is merely adopted to power the network phone adapter 100. Furthermore, as shown in FIG. 2, the power supplying circuit 110 comprises a plurality of capacitors and resistors, which can be regarded as a voltage regulator (i.e., low-pass filter) for performing a voltage regulation function on the above-mentioned voltage level +5V so that the power supplying circuit 110 can provide stable and clean voltage levels (+Vp and +Vₜₕ shown in FIG. 2) to the whole network phone adapter 100. Please note that the resistance values and capacitance values shown in FIG. 2 are only meant to serve as examples and are not meant to be taken as limitations.

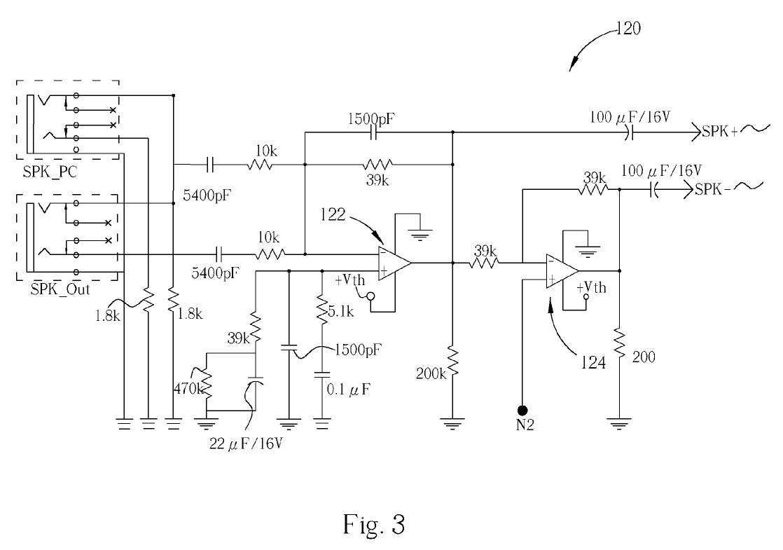

Please refer to FIG. 3, which is a circuit diagram of the speaker driving circuit 120 shown in FIG. 1. As one can see, the speaker driving circuit 120 is connected to the PC 160 through the terminal SPK_PC shown in FIG. 3. In one embodiment, the speaker driving circuit 120 is connected to an audio processing chip, a soundcard for example, of the PC 160 via a wire to receive the audio signal associated with the network phone signal. Furthermore, again referring to FIG. 3, the speaker driving circuit 120 makes use of two OP amplifiers 122, 124 (e.g., TLC274SD) to transform the received stereo audio signal into a mono audio signal SPK+, SPK− and transfer the processed mono audio signal SPK+, SPK− to the next stage, the phone signal converting circuit 140. Furthermore, the speaker driving circuit 120 comprises a plurality of capacitors and resistors used as a filter for filtering out unwanted signals. The functionality of the phone signal converting circuit 140 is illustrated later. Please note that the speaker driving circuit 120 can also support an external speaker connected to the terminal SPK_Out shown in FIG. 3. Therefore, the network phone adapter 100 has improved elasticity. In addition, the resistance values and capacitance values shown in FIG. 3 are only meant to serve as an example and are not meant to be taken as limitations.

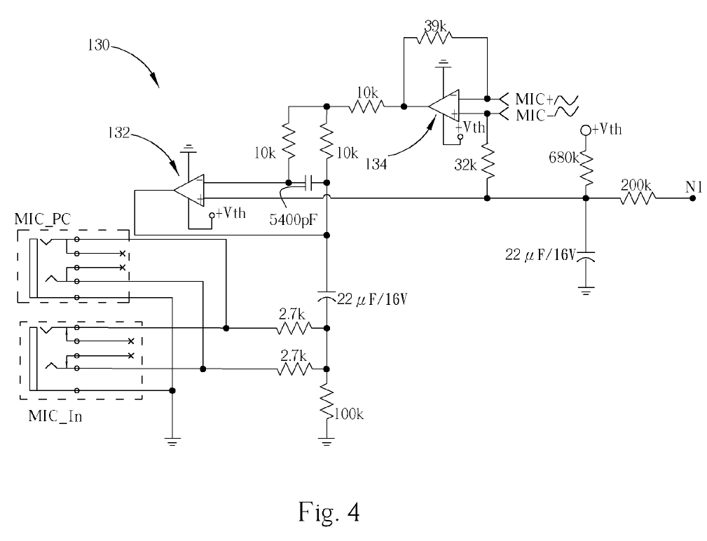

Please refer to FIG. 4, which is a circuit diagram of the microphone driving circuit 130 shown in FIG. 1. First, a node N₂ shown in FIG. 4 is electrically connected to node N₁ shown in FIG. 3. The microphone driving circuit 130 is quite similar to the above-mentioned speaker driving circuit 120. The major difference between them is the transmission route of a received signal. That is, the audio signal within the speaker driving circuit 120 is transferred from the PC 160 to the normal phone 170; however, the audio signal within the microphone driving circuit 130 is transferred from the normal phone 170 to the PC 160 through the terminal MIC_PC shown in FIG. 4. Therefore, the microphone driving circuit 130 is also connected to the PC 160. In one embodiment, the microphone driving circuit 130 is connected to the audio processing chip (i.e., the soundcard) of the PC 160 via a wire to send the processed audio signal to the PC 160. Furthermore, referring to FIG. 4 again, the microphone driving circuit 130 makes use of two OP amplifiers 132, 134 (e.g., TLC274SD) to transform the mono audio signal MIC+, MIC−, which is transferred from the previous stage, i.e., the phone signal converting circuit 140, into a stereo audio signal and then transfer the stereo audio signal to the PC 160 through the terminal MIC_PC. Furthermore, the microphone driving circuit 130 comprises a plurality of capacitors and resistors used as a filter for filtering out unwanted signal. Please note that the microphone driving circuit 130 can also support an external microphone connected to the terminal MIC_In shown in FIG. 4. Therefore, the network phone adapter 100 has improved elasticity. Please note that the resistance values and capacitance values shown in FIG. 4 are only meant to serve as examples and are not meant to be taken as limitations.

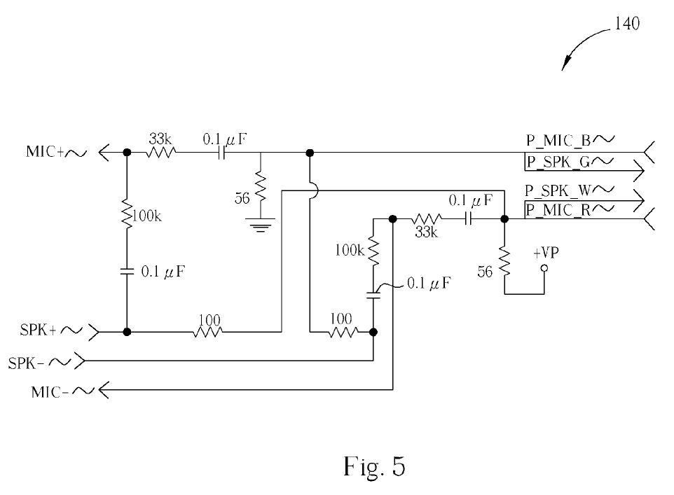

The functionality of the phone signal converting circuit 140 is described as follows. Please refer to FIG. 5, which is a circuit diagram of the phone signal converting circuit 140 shown in FIG. 1. As mentioned above, the phone signal converting circuit 140 is electrically connected to the microphone driving circuit 130 and the speaker driving circuit 120 for bridging the audio signal MIC+, MIC−, SPK+, SPK− and the phone signal P_MIC_B, P_MIC_R, P_SPK_G, P_SPK_W between the normal phone 170 and the PC 160. Referring to FIG. 5, the phone signal converting circuit 140 provides two DC levels, that is, the ground voltage and +VP, and is capable of transferring the audio signal SPK+, SPK− generated from the speaker driving circuit 120 to the normal phone 170 or transferring the phone signal P_MIC_B, P_MIC_R to the microphone driving circuit 130. Furthermore, the phone signal converting circuit 140 utilizes resistors and capacitors to serve as low-pass filters for filtering out unwanted noise, and provides negative and positive voltage levels so that the converted audio signal P_SPK_G, P_SPK_W can comply with the specification defined for the normal phone 170. In addition, the phone signal P_MIC_B, P_MIC_R can be converted in to the wanted audio signal MIC+, MIC−. Please note that the resistance values and capacitance values shown in FIG. 5 are only meant to serve as examples and are not meant to be taken as limitations.

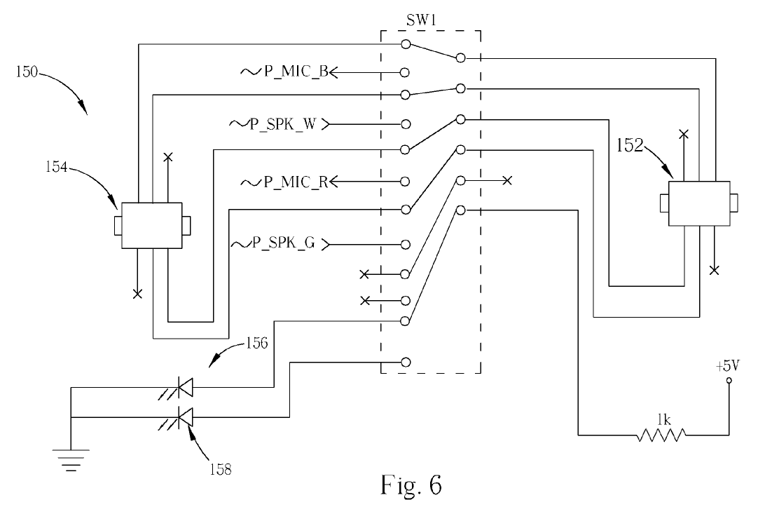

Please refer to FIG. 6, which is a circuit diagram of the switching circuit 150 shown in FIG. 1. The switching circuit 150 is connected between the normal phone 170, the telecom system 180, and the phone signal converting circuit 140. A phone jack 152, which has six connecting nodes, is used to connect the normal phone 170, while the other phone jack 154, which has six connecting nodes, is used to connect the telecom system 180. The switching circuit 150 is utilized to select the function of the normal phone 170. That is, the switching circuit 150 can determine the normal phone 170 to be a normal phone or to serve as the microphone and speaker required by the network phone. As shown in FIG. 6, the switching circuit 150 comprises a switch SW1 to determine the transmission route of the incoming signal. In other words, if the normal phone 170 is selected to perform its original defined functionality, the switching circuit 150 utilizes the switch SW1 to connect the telecom system 180 to the normal phone 170 through coupling the phone jack 154 to the phone jack 152. On the other hand, if the normal phone 170 is selected to act as the microphone/speaker needed by the network phone, the switching circuit 150 utilizes the switch SW1 to couple the phone signal P_MIC_B, P_MIC_R, P_SPK_G, P_SPK_W to the phone jack 152 so that the normal phone 170 and the PC 160 can successfully communicate with each other. Please note that the LEDs 156, 158 here are implemented to emit indicating light for informing the user of the working mode run by the normal phone 170.

Please note that the circuit structure of the power supplying circuit 110 is only for illustration, and is not a limitation. In other words, the power supplying circuit 110 can be a battery or be connected to an external power supply. In addition, the power supplying circuit 110 is not limited to being connected to the PC through the USB interface.

Please note that the switching circuit 150 is an optional device. In other words, the phone adapter 100, acting as a pure adapter for the network phone, can operate without the switching circuit 150. The phone adapter 100 shown in FIG. 1 is only a preferred embodiment of the present invention.

In contrast to the prior art, the present invention network phone adaptor bridges signals between a computer and a normal phone so that the present invention can utilize a normal phone as a microphone and a speaker of the computer. Therefore, users do not have to spend additional money on buying these devices. Furthermore, the present invention network phone adaptor utilizes the normal phone to serve as either a normal phone or a network phone so that the normal phone becomes a multi-function phone.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A phone adaptor capable of utilizing a normal phone to serve as at least a speaker of an electronic device, the phone adaptor comprising:
a speaker driving circuit electrically connected to the electronic device for processing an audio signal outputted by the electronic device; and
a phone signal converting circuit electrically connected to the speaker driving circuit for converting the processed audio signal into a phone signal complying with a specification of the normal phone and for driving the normal phone using the phone signal.

2. The phone adaptor of claim 1 further comprising:
a switching circuit electrically connected to the phone signal converting circuit, the normal phone, and a normal telecommunication system, the switching circuit for connecting the normal phone to the phone signal converting circuit or connecting the normal phone to the normal telecommunication system;
wherein the switching circuit establishes a connection between the phone signal converting circuit and the normal phone when the normal phone is used to serve as the speaker.

3. The phone adapter of claim 1 further comprising:
a power supplying circuit electrically connected to the electronic device, the speaker driving circuit, and the phone signal converting circuit, the power supplying circuit for draining a voltage level from the electronic device and supplying the voltage level to the speaker driving circuit and the phone signal converting circuit.

4. The phone adapter of claim 3 wherein the power supplying circuit comprises:
a voltage regulator for regulating the voltage level.

5. The phone adapter of claim 4 wherein the power supplying circuit is electrically connected to the electronic device through a universal serial bus (USB) interface, and the voltage level is supplied by the USB interface.

6. The phone adapter of claim 5 wherein the electronic device is a personal computer (PC).

7. The phone adaptor of claim 1 wherein the audio signal complies with a specification of a network phone.

8. The phone adaptor of claim 1 wherein the electronic device is a personal computer (PC), and the speaker driving circuit is electrically connected to an audio processing chip of the PC.

9. The phone adaptor of claim 1 wherein the audio signal outputted by the electronic device is a stereo audio signal, and the speaker driving circuit comprises an amplifier circuit for transforming the stereo audio signal into a mono audio signal and outputting the mono audio signal to the phone signal converting signal.

10. A phone adaptor capable of utilizing a normal phone to serve as at least a microphone of an electronic device, the phone adaptor comprising:
a phone signal converting circuit for converting a phone signal outputted from the normal phone into an audio signal; and
a microphone driving circuit electrically connected to the electronic device and the phone signal converting circuit for receiving the audio signal, processing the audio signal, and transferring the processed audio signal to the electronic device.

11. The phone adaptor of claim 10 further comprising:
a switching circuit electrically connected to the phone signal converting circuit, the normal phone, and a normal telecommunication system, the switching circuit for connecting the normal phone to the phone signal converting circuit or connecting the normal phone to the normal telecommunication system;
wherein the switching circuit establishes a connection between the phone signal converting circuit and the normal phone when the normal phone is used to serve as the microphone.

12. The phone adapter of claim 10 further comprising:
a power supplying circuit electrically connected to the electronic device, the microphone driving circuit, and the phone signal converting circuit, the power supplying circuit for draining a voltage level from the electronic device and supplying the voltage level to the microphone driving circuit and the phone signal converting circuit.

13. The phone adapter of claim 12 wherein the power supplying circuit comprises:
a voltage regulator for regulating the voltage level.

14. The phone adapter of claim 13 wherein the power supplying circuit is electrically connected to the electronic device through a universal serial bus (USB) interface, and the voltage level is supplied by the USB interface.

15. The phone adapter of claim 14 wherein the electronic device is a personal computer (PC).

16. The phone adaptor of claim 10 wherein the audio signal complies with a specification of a network phone.

17. The phone adaptor of claim 10 wherein the electronic device is a personal computer (PC), and the microphone driving circuit is electrically connected to an audio processing chip of the PC.

18. The phone adaptor of claim 10 wherein the audio signal outputted by the normal phone is a mono audio signal, and the microphone driving circuit comprises an amplifier circuit for transforming the mono audio signal into a stereo audio signal and outputting the stereo audio signal to the electronic device.

19. A phone adaptor capable of utilizing a normal phone to serve as a speaker and a microphone of an electronic device, the phone adaptor comprising:
a speaker driving circuit electrically connected to the electronic device for processing a first audio signal outputted from the electronic device;
a microphone driving circuit electrically connected to the electronic device for processing a first phone signal outputted from the normal phone; and
a phone signal converting circuit electrically connected to the speaker driving circuit and the microphone driving circuit, the phone signal converting circuit either for converting the processed first audio signal into a second phone signal complying with a specification of the normal phone or for converting the processed phone signal into a second audio signal.

20. The phone adaptor of claim 19 wherein the first and second audio signals comply with a specification of a network phone, the electronic device is a personal computer (PC), and the speaker driving circuit and the microphone driving circuit are electrically connected to an audio processing chip of the PC.
